(19) United States
(12) Patent Application Publication
(10) Pub. No.: US 2013/0020310 A1
(43) Pub. Date: Jan. 24, 2013

(54) SYSTEM AND METHOD FOR MONITORING AND CONTROLLING HEATING/COOLING SYSTEMS

(71) Applicant: Sasson Yuval Hacham, Zichron Yaacov (IL)

(72) Inventor: Sasson Yuval Hacham, Zichron Yaacov (IL)

(21) Appl. No.: 13/552,640

(22) Filed: Jul. 19, 2012

(30) Foreign Application Priority Data
Jul. 19, 2011 (IL) 214189

(51) Int. Cl. F24H 9/20; F24H 1/20

(52) U.S. Cl. 219/442; 219/494; 219/510; 219/441

(57) ABSTRACT

A monitoring and control system for monitoring and controlling at least one thermal regulation system (TRS), where the monitoring and control system includes a thermal sensor for sensing temperature in the TRS; a controller, operatively associated with the TRS and the thermal sensor, where the controller receives data from the thermal sensor including temperature measurements thereof and analyzes the data for allowing disconnecting TRS from its power supply once the temperature in the TRS, sensed by the sensor, reaches at least one predefined threshold; and a breaking mechanism, operatively associated with the controller, including at least one circuit breaker for allowing disconnecting the TRS from its power supply when identifying an electrical overload or once disconnected by the controller operatively associated therewith.

### CROSS-REFERENCE TO RELATED PATENT APPLICATIONS

This application claims priority to Israeli patent application No. 214189 filed on Jul. 19, 2011, which is incorporated herein by reference in its entirety.

### FIELD OF THE INVENTION

At least one embodiment of the invention generally relates to thermal regulation systems and more particularly to systems and methods for monitoring and controlling thermal regulation systems.

### BACKGROUND OF THE INVENTION

Heating and/or cooling systems such as water boiler tanks, central heating systems, heating and/or cooling radiators and the like, are commonly used and often require temperature regulation and controlling for safety and/or energy saving purposes. In heating systems temperature regulation is necessary to prevent the liquid or gas running through the system from exceeding a threshold temperature to prevent damaging the system and/or even physically endangering people in the vicinity of the system. A water boiler, for example, requires a mechanism that will prevent the water temperature in a water tank thereof to reach an upper threshold temperature (such as 90° C.) to prevent pressure in the tank from rising to levels that may cause the tank to explode.

Many safety and control mechanisms for controlling water boilers are currently available and utilized such as mechanical thermostats, using mechanical sensors such as Bi-metal sensors (often called “bimetallic strips”) that sense changes in the water temperature by sensing mechanical displacements (expansion/contraction) of one or more metal plates inserted to a portion of the water tank. Mechanical sensing has many limitations; one is that this method is extremely inaccurate since the plates do not respond to all changes in the same linear manner. This may lead to errors in temperature measuring that may cause energy lose and/or, in some cases, allowing the water in the container to overheat. Another downside is that these metal plates are easily eroded over time and change the manner in which they physically respond to temperature changes. Another hazardous downside is that these metal plates do not respond the same to changes in temperature of air and therefore if the boiler tank is for some reason depleted or semi-depleted, the plates will not be able to sense that only the metal tank itself is heated, which may lead to an extremely dangerous explosion of the tank once water are poured back therein.

### BRIEF SUMMARY OF THE INVENTION

According to some embodiments of the invention, there is provided a monitoring and control system for monitoring and controlling at least one thermal regulation system (TRS). The monitoring and control system comprises a) at least one thermal sensor for sensing temperature in the TRS; b) a controller, operatively associated with the TRS and the thermal sensor, where the controller receives data from the thermal sensor including temperature measurements thereof and analyzes the data for allowing disconnecting TRS from its power supply once the temperature in the TRS, sensed by the sensor, reaches at least one predefined threshold; and c) a breaking mechanism, operatively associated with the controller, comprising at least one circuit breaker for allowing disconnecting the TRS from its power supply when identifying an electrical overload or once disconnected by the controller operatively associated therewith.

Optionally, the TRS is a heating system comprising at least one container for containing a substance therein such as liquid (e.g. water) or gas, and at least one heating element inserted in a first inlet therein for heating the substance, wherein the sensor is inserted in a second inlet of the container and the controller enables disconnecting power supply to the heating system once temperature in the container reaches a predefined threshold temperature Tₘₐₓ.

The monitoring and control system may further comprise at least one display and control unit, which receives data from the controller including currently sensed temperature of the TRS and enables displaying thereof using at least one display unit associated therewith.

According to some embodiments the TRS is a water boiler comprising a water container and at least one heating element for heating the water therein. The controller may connect to at least one relay connected to the heating element for allowing disconnecting and reconnecting the heating element. Additionally or alternatively, the display and control unit enables a user to control settings of the heating system by allowing the user to set at least one of: a maximal heating temperature Tₘₕ, wherein the controller enables disconnecting the heating element once the temperature reaches the Tₘₕ; a reheating temperature difference ΔTᵣₕ, wherein the controller allows reconnecting the heating element once the difference between the Tₘₕ and a currently sensed temperature Tᵢ of the substance in the heating system reaches ΔTᵣₕ; a timing setup, which allows automatic switching of the heating element on by the controller according to the timing setup.

The controller may further enable assessing a relative heating parameter, indicative of a portion of the substance in the container that has reached the maximal heating temperature Tₘₕ, wherein the display unit enables indication thereof.

Optionally, the display unit comprises at least one of: an electronic screen, indicator light sources, and/or an electromechanical indicator.

The controller may further enable monitoring temperature changes in the heating system over time and disconnecting power supply to the heating system, using the breaking mechanism, once identifying abnormal temperature changes (e.g. changes that are under a predefined threshold). For example, the controller checks whether the temperature in the heating system has not changed over a predefined time period t₀ more than a predefined threshold temperature change ΔTₘᵢₙ and disconnects the heating system once each of the changes within t₀ is lower than ΔTₘᵢₙ. The minimum temperature threshold ΔTₘᵢₙ and the time period t₀ may be predefined and may be set according to predefined safety standards. Unchanged temperature over time or too small changes may indicate that the sensor is either disconnected from its power supply, defected in any other way or dislocated in a sense that the sensor is not located within or near what it should sense (e.g. within the water container).

Optionally, at least one of the display and control unit is a proximal display and control unit located in vicinity to the heating system and controller and at least one of them is a remote display and control unit for allowing users to view data relating to the heating system and optionally to change settings and input parameters and the like for defining and controlling functionality thereof from remote locations, each remote display and control unit communicates with the controller via at least one communication link, which may be a wireless communication link (e.g. based on cellular radio frequency (RF) communication) or a wired communication link (e.g. through communication wiring).

Additionally or alternatively, the monitoring and control system further comprises at least one relay connected to the controller to allow disconnecting and reconnecting heating element thereto for controlling power supply to the heating element thereby.

Additionally or alternatively, the sensor comprises at least one of: at least one thermistor, a thermocoupler, and/or a resistance thermometer.

According to some embodiments of the invention, there is provided a method of monitoring and controlling at least one thermal regulation system (TRS), using a monitoring and control system for monitoring and controlling the TRS. The method comprises: monitoring temperature of at least part of the TRS, using at least one sensor of the monitoring and control system; disconnecting power supply to the TRS when the sensed temperature exceeds a predefined threshold, using a controller of the monitoring and control system, for carrying out the monitoring and at least one circuit breaker, of the monitoring and control system, for disconnecting and reconnecting of the TRS from power supply, the controller receives data from the sensor and controls the circuit breaker.

The method may further include receiving input data from a user, the data allows setting controlling and monitoring parameters of the monitoring and control system using at least one control and settings unit thereof operatively associated with the controller. The data may include, for instance, at least one of: a maximal heating temperature Tₘₕ, wherein the controller enables disconnecting the heating element once the temperature reaches the Tₘₕ; a reheating temperature difference ΔTᵣₕ, wherein the controller allows reconnecting the heating element for allowing it to reheat the substance once the difference between the Tₘₕ and the a currently sensed temperature of the substance in the heating system reaches ΔTᵣₕ; a timing setup, which allows automatic switching on the heating element by the controller according to the setup.

Temperature changes in the TRS may optionally be monitored over time, where power supply thereto is disconnected, using the breaking mechanism, once identifying abnormal temperature changes. The controller checks whether the temperature in the heating system has not changed over a predefined time period t₀ more than a predefined threshold temperature change ΔTₘᵢₙ and disconnects the TRS once each of the changes within t₀ is lower than ΔTₘᵢₙ.

The monitoring and control system may further enable users to set at least one of: the minimum temperature threshold ΔTₘᵢₙ, the time period t₀. Alternatively, the minimum temperature threshold ΔTₘᵢₙ and the time period t₀ are predefined and are set according to predefined safety standards.

### BRIEF DESCRIPTION OF THE DRAWINGS

FIG. 1 is a block diagram, schematically illustrating a monitoring and control system for a water boiler, according to some embodiments of the invention;

FIG. 2 is a block diagram, schematically illustrating a display and control unit of the system, according to some embodiments of the invention; and

FIG. 3 is a flowchart, schematically illustrating a process of monitoring and controlling a water boiler, according to some embodiments of the invention.

FIG. 4A schematically illustrates a circuit for detecting connection of the heating system to an electric grounding, according to one embodiment of the invention.

FIG. 4B schematically illustrates a circuit for detecting connection of the heating system to an electric grounding, according to another embodiment of the invention.

FIG. 5 schematically illustrates a monitoring and control system for a water boiler having a remote controller wirelessly communicative with a local controller through a cellular communication modem, according to some embodiments of the invention.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the invention.

At least one embodiment of the invention provides methods and systems for monitoring and controlling a thermal regulation systems (TRSs), which are heating and/or cooling systems such as water boilers, cooling radiators (e.g. for vehicles), heating radiators, central heating systems, and the like. These TRSs typically include one or more containers for containing and optionally circulating a liquid or a gas such as water, oil, etc. which carries the heat or cools another system and/or a predefined space in which it is installed.

At least one embodiment of the invention provides systems and methods that can monitor the temperature inside the containers of these heating or cooling systems using one or more thermal sensors such as a thermistor, a thermocoupler, a resistance thermometer and the like and control the heating/cooling system by, for example, enabling to disconnect and optionally reconnect the heating/cooling system or parts thereof from its/their power supply.

For example in case of a water boiler heating system comprising a water tank container and one or more heating elements, positioned within the tank to enable heating the water therein, the monitoring and control system may enable disconnecting and then reconnecting power supply to the heating element using one or more circuit breakers such as a residual circuit breaker or any other switching mechanism, which can disconnect both TRS and monitoring and control system from its power supply once (i) sensing an electrical overload and/or short circuit; as well as (ii) once disconnected by a controller of the monitoring and control system that allows disconnection of the heating system under one or more predefined conditions.

According to some embodiments of the invention, the monitoring and control system includes one or more thermal sensors such as a thermistor for sensing the temperature in the TRS, a controller for receiving data from the sensor and controlling the TRS and a breaking mechanism operatively associated with the controller for allowing disconnecting the TRS from power supply.

According to some embodiments, the sensor is positioned in a manner that allows it to sense the temperature in at least a portion inside a container of the TRS. For example, in case of a water boiler, the sensor may be inserted into the water tank through a designated inlet. The sensor may sense the temperature of the water in the tank every time interval (e.g. every few seconds) or in a continuous manner and output data including the sensed temperature to the controller.

The controller, which is operatively associated with the TRS, the thermal sensor and the circuit breaker, analyzes the sensor data for allowing disconnecting TRS from its power supply once one or more conditions are detected. In each condition, the controller is preset to carry out one or more functions such as disconnecting all systems (the water boiler and the monitoring and control system) from their power supply, disconnecting the heating element only, and the like. The conditions for disconnecting the entire power supply may include, for instance, identifying that the temperature in the tank has reached a predefined maximal threshold, which may be adjustable by a user or only by an authorized user or preset by the manufacturer, to allow adapting the maximal temperature to the regulations of the country/region where the monitoring and control system is used. For example, in Israel the standard maximum temperature for most water boilers for domestic utilization is 95° C. In this case the maximum temperature may be set to this value in a manner that no unauthorized person can change it to make sure standards and safety are secured.

According to some embodiments of the invention, the monitoring and control system also includes one or more display and control units, each enabling users to set some of the monitoring and/or controlling parameters of the system such as a maximal heating temperature Tₘₕ, for allowing the controller to disconnect the heating element once the temperature reaches Tₘₕ, a reheating temperature difference ΔTᵣₕ, allowing the controller to reconnect the heating element for allowing it to reheat the water in the tank, once the difference between Tₘₕ and a currently sensed temperature Ti reaches ΔTᵣₕ, and/or a timing setup, which allows automatic switching on and/or off of the heating element according to the setup parameters, which can be set by the user. The display and control system may also enable displaying setup parameters, currently sensed temperature, or any other parameter related to the TRS and/or control conditions.

The controller may additionally allow monitoring temperature changes in the container (e.g. water tank) over time and disconnecting power supply thereto, using the breaking mechanism, once identifying abnormal temperature changes. Abnormal temperature changes may be defined as temperature changes that are smaller and/or higher than predefined values over time while the heating element is turned on. This may be caused due to disconnecting or displacement of the sensor (which may lead to overheating if not checked), non-operable sensor, disconnecting or displacement of the heating element from the tank and/or any other causes that may cause endangering situations and/or other errors. In this case, the controller checks whether the temperature in the tank has not changed over a predefined time period t₀ more than a predefined threshold temperature change ΔTₘᵢₙ and disconnects the entire system (using the circuit breaker) or only the heating element once each of the changes within t₀ is lower than ΔTₘᵢₙ. The monitoring and control system may enable users to set the values of ΔTₘᵢₙ, and t₀ or alternatively, these values may be predefined and unchangeable in the system to allow this safety mechanism to be set according to predefined safety standards.

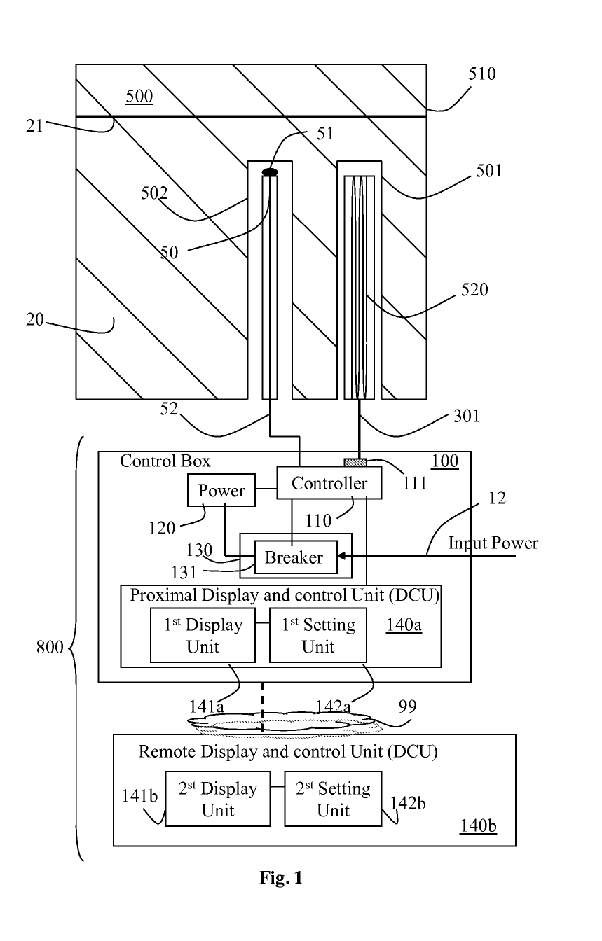

Reference is now made to FIG. 1, which schematically illustrates a monitoring and control system (MCS) 800 connected to a water boiler heating system 500 for monitoring and controlling thereof, according to some embodiments of the invention. Water boiler 500 includes a water tank 510, which is a container that can be filled with water for heating thereof, and a heating element 520 for allowing to heat the water in the tank. Heating element 520 is positioned inside a designated first inlet 501, which is a perforated sleeve inside tank 510.

According to some embodiments of the invention, as illustrated in FIG. 1, MCS 800 includes (i) at least one sensor such as thermistor 50, which is a sensor 51 connected through a wire 50 that can be inserted into tank 510 thorough a second inlet 502; (ii) a control box 100 connected to the thermistor 50 through wire 51; and (iii) one or more remote display and control units (DCU) such as DCU 140b. Remote DCU 140b may be connected to control box 100 through any one or more communication links such as through a wireless and/or wired communication link. For example, remote DCU 140b can wirelessly communicate with control box 100 through a radio frequency (RF) communication channel using a predefined RF frequency range and settings for short-range communication reaching up to 50 meters radius.

Control box 100 includes a controller 110, a power supply component 120, a breaking mechanism 130, comprising at least one circuit breaker 131, and a proximal DCU 140a. Controller 110 connects to thermistor 50 to receive data therefrom such as temperature measured by thermistor 50. Controller 110 additionally connects to power supply component 120, proximal and remote DCUs 140a and 140b and to breaking mechanism 130. Circuit breaker 131, which may be a bipolar circuit breaker may be connected to the main power supply and may disconnect and reconnect both water boiler 500 and MCS 800 from the power upon a short circuit or an electrical overload (a case in which the difference between the input and output current exceeds a predefined threshold) or by controller 110.

Controller 110 may include any one or more hardware and/or software components capable of operating circuit breaker 131 and optionally heating element 520 according to a program, which may be predefined and additionally or alternatively programmable by the user. For example, some parameters such as Tₘₐₓ may be predefined and unchangeable while other parameters may be programmable by the user having default values.

For instance, controller 110 may include a microcontroller such as complementary metal-oxide semiconductor (CMOS) microcontrollers such as an 8-bit single-chip of serial no. SAM88RCRI microcontroller by Samsung™, which includes a memory, a processor core and programmable peripherals on an integrated circuit. The microcontroller allows programming digital/analog functions and conditions for carrying out thereof.

According to some embodiments of the invention, controller is a SAM88RCRI microcontroller, sensor 50 is a PT100 resistance thermometer, heating element 520 is an ALM heating element 230V/2500 W, power supply 120 is a Siemens™ 220V/12V power supplier, and circuit breaker is a residual current circuit breaker (RCCB) by Siemens™ 2X40A.

According to some embodiments of the invention, controller 110 is configured to allow disconnecting power supply to the water boiler 500 by switching circuit breaker 131 off respectively, and/or disconnecting and reconnecting heating element 520 by switching off/on a designated relay 111 connected thereto. Controller 110 may switch off heating element 520 and/or circuit breaker 131 upon identification of situations or conditionings requiring such disconnecting. Additionally, controller 110 enables reconnecting heating element 520 by switching on relay 111 upon identification of reconnecting conditions. Circuit breaker 131 may only be able to switch back on manually.

According to some embodiments of the invention, controller 110 disconnects circuit breaker 131 once the sensed temperature reaches a maximal threshold Tₘₐₓ which may be predefined in Controller 110 according to national, regional, and/or international standards and according to the specific heating/cooling system it monitors and controls. For example, the standard maximal water temperature for water boilers is typically 95° C. Tₘₐₓ may be defined in a manner that either enables or does not enable users to change it. Changing Tₘₐₓ may be permissible to allow using the same MCS 800 for different thermal regulation systems and/or for adjusting it to various standards of different countries, regions etc. Alternatively, Tₘₐₓ may be predefined in a manner that does not allow changing thereof for safety purposes, preventing thereby from users to change it to hazardous values.

Optionally, controller may enable disconnecting heating element 520 from power supply to allow ceasing to heat the water in tank 500 according to another temperature threshold, defined herein as a maximal heating temperature Tₘₕ that can be controlled and adjusted by the user. Tₘₕ is a temperature limit that the user and/or manufacturer desires water in tank 510 to reach before ceasing heating thereof typically in the range of 60-80° C. for domestic utilization of water boilers for saving energy and preventing heating element 520 from reaching the ultimate and endangering threshold of T. For this reason a separate disconnecting mechanism of relay 111 is combined to controller 110 to allow reconnecting heating element 520 upon a predefined and/or settable temperature decline.

This means that the user can use any one of proximal and/or remote DCUs 140a and/or 140b to input and define Tₘₕ and also a rate parameter of the temperature decline referred to herein as a reheating temperature difference ΔTᵣₕ, which is the absolute value of the difference between Tₘₕ and the currently sensed/measured temperature Ti (ΔT=Tₘₕ−Ti). This means that if ΔT>ΔTᵣₕ controller 110 switches relay 111 on to reconnect heating element 520 and thereby enable reheating water in tank 510. As mentioned, both ΔTᵣₕ and Tₘₕ may be adjustable through DCUs 140a and/or 140b to allow adjusting these values according to personal utilization requirements of the users and/or according to economic considerations such as according to the number of people that are expected to tank a shower, etc.

Additionally or alternatively, DCUs 140a and/or 140b enable to set a timer defining timing setup, which may, for example allow users to determine when heating element 520 is switched on for heating and when heating of the water should cease. These functions may also be carried out by controller 110 using relay 111.

According to some embodiments of the invention, as illustrated in FIG. 1, proximal DCU 140a may be positioned inside control box 100 and in a vicinity of water boiler 500, while remote DCU 140b may be located at a different location that is determined by the user(s) according to their convenience and considerations. Additionally, proximal DCU 140a may include a first display unit 141a and a first setting unit 142a, and remote DCU 140b may include a second display unit 141b and a second setting unit 142b, respectively. Each display unit may include an electronic screen such as a seven-segment G5518RD screen, indicator light sources, electromechanical indicator, graphical display system and the like.

Each first/second display unit 141a/141b may include at least one display device such as a screen enabling displaying of data such as displaying currently measured temperature Ti in tank 510, Tₘₕ, ΔTᵣₕ, timing settings, Tₘₐₓ, and the like. Each first/second setting unit 142a/142b may include an input platform enabling the user to input parameters and definitions such as Tₘₕ, ΔTᵣₕ, timing settings, T. and the like.

According to some embodiments of the invention, as mentioned above, the system (via the controller 110 and the DCUs 140a and 140b) allows all users of the system to change some of the system's parameters, while allowing only authorized users to change other more crucial parameters such as the maximal temperature set for heating Tₘₕ. This can be done by only allowing access to designated menu interfaces of the controller 110 via security entrance means such as through one or more access codes (e.g. user name and password).

According to some embodiments of the invention, controller 110 may additionally or alternatively include a safety mechanism in which controller 110 monitors temperature changes over time and disconnects power supply to the systems 800 and 500, using circuit breaker 131, once identifying abnormal temperature changes. These changes may include no temperature change or very small temperature change indicating that the sensor 51 and/or the heating element 520 is either non-operable or has been removed from the water container 500. For this purpose, controller 110 may first check whether heating element 520 should be connected under other conditions (e.g. if boiler 500 is on and if temperature has not reached Tₘₕ, for instance) and if heating element 520 should be operated, controller 110 may verify whether the temperature has not changed over a predefined time period t₀ more than a predefined threshold temperature change ΔTₘᵢₙ. Controller 110 may be set to disconnects the entire boiler 500 using circuit breaker 131, once each of the changes within t₀ is lower than ΔTₘᵢₙ.

This means that controller 110 checks every few time-intervals the difference between the current temperature Tₙ and the previously measured temperature τ(n) calculating: Δn=Tₙ−Tₙ₋₁ and if none of Δn exceeds ΔTₘᵢₙ over time period t₀, controller 110 automatically disconnects systems 800 and 500 by switching circuit breaker 131 off.

The safety mechanism may prevent over heating in cases in which, for example, heating element is pulled out of first inlet 501 for some reason and no longer heats water in tank 510, and/or in cases in which sensor 50 is pulled out of second inlet 502. The minimum temperature threshold ΔTₘᵢₙ and time period t₀ may be predefined and set according to predefined safety standards.

According to some embodiments of the invention, controller 110 can also analyze the sensor data to evaluate or assess a relative heating parameter (RHP), indicative of a portion of the water in tank 510 that has reached the maximal heating temperature Tₘₕ that has been set by the user/manufacturer. An indication of RHP may be presented through first and/or second display units 141a and/or 141b, respectively.

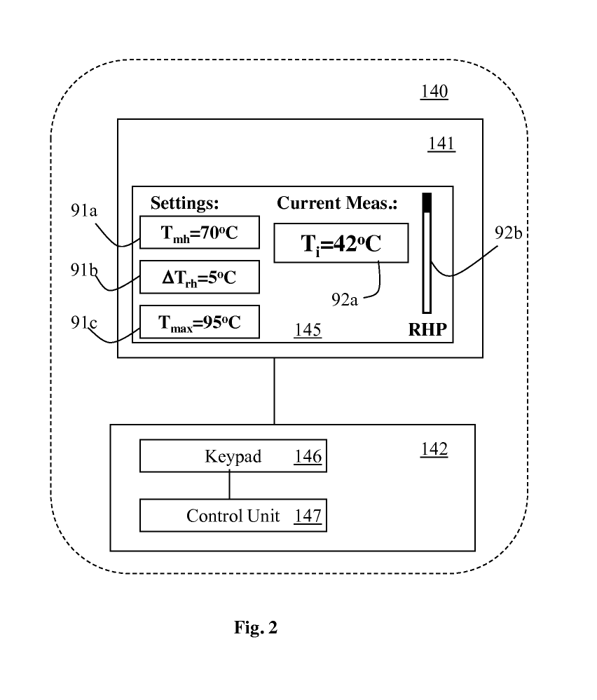

Reference is now made to FIG. 2, schematically showing a general display and control unit (DCU) 140 having a screen 141 for enabling to display the parameters specified above and a settings unit 142 for enabling a user to input data and/or adjust values of some of these parameters. Settings unit 142 may include one or more input devices such as a keypad 142 and a control unit 147 including one or more settings programs and menus operated thereby.

For example, as illustrated in FIG. 2, the display enables displaying defined settings such as: Tₘₕ 91a, ΔTᵣₕ 91b and Tₘₐₓ 91c as well as currently measured and/or evaluated/calculated parameters such as current temperature measurement Ti 92a and/or RHP assessment 92b. Indication of the RHP estimation 92b may include for example, a bar having an indication of a relative portion of tank 510 that has reached Tₘₕ colored in white and the other portion colored in black.

Control unit 147 may allow operating a specially designated user interface (UI) for presenting the user with settings menu through screen 145 allowing the user to use keypad 145 and optionally another input device such as a mouse, a touch pad and the like to adjust values of parameters such as Tₘₕ 91a, ΔTᵣₕ 91b and Tₘₐₓ 91c, and/or timer settings, whilst viewing indication thereof on screen 145.

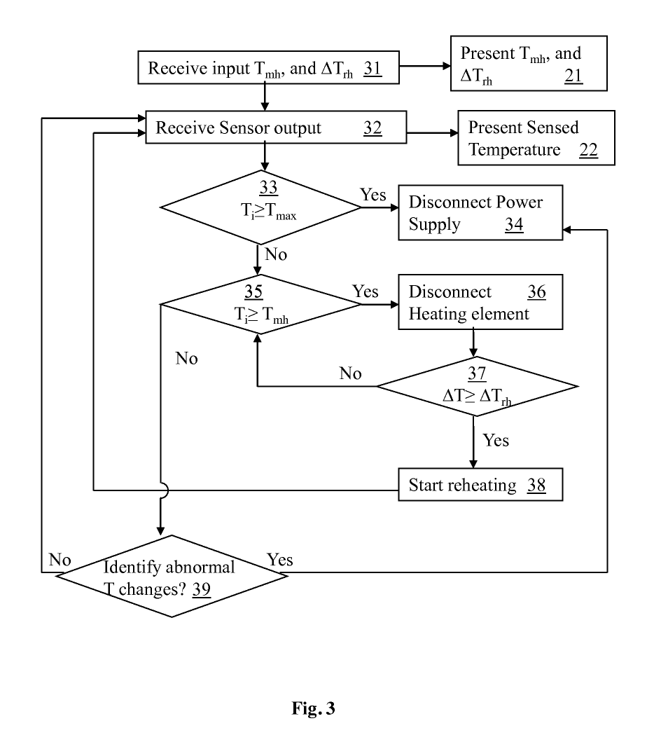

Reference is now made to FIG. 3, which is a flowchart schematically illustrating some of the processes enabled by MCS 800, according to some embodiments of the invention. According to these embodiments, controller 110 enables receiving input parameters Tₘₕ and ΔTᵣₕ from one of DCUs 140, 140a and/or 140b as indicated in step 31, where other parameters such as Tₘₐₓ, t0, ΔTₘᵢₙ and the like are predefined therein as indicated in step 32, as well as receiving data from sensor 50 including Tᵢ. All these predefined/adjusted parameters may be presented by presentation units 141, 141a and/or 141b as indicated in steps 21 and 22.

Controller 110 may then check if the currently measured temperature Ti exceeds or reaches Tₘₐₓ and if so disconnect power supply 34 by switching circuit breaker 131 off, for instance. If Ti does not exceed or reach Tₘₐₓ controller may check whether Ti reaches or exceeds Tₘₕ, set by the user and if so disconnect heating element 520 only through relay 11, for instance 36.

Once heating element 520 is disconnected 36, controller 110 continuously checks if the difference between Ti and TmhΔT does not exceed or reaches adjusted difference threshold ΔTᵣₕ 37 and if so—controller 110 switches relay 111 on again 38 and thereby restarts heating water in tank 510. If Ti does not exceed or reach Tₘₕ 35, controller 110 checks whether any abnormal temperature changes are detected 39 as explained above. If such changes are detected, controller 110 automatically disconnects MCS 800 as well as water boiler 500 by switching off circuit breaker 131.

According to some embodiments of the invention, the monitoring and control system may be operatively associated with several heating/cooling systems for monitoring and controlling thereof allowing an authorized person for instance, to monitor and control all these systems from a remote location using the remote display and control unit. The controller in this case may enable controlling a multiplicity of circuit breakers, each belonging to a different heating/cooling system and a multiplicity of relays each connected to a different heating element.

According to some embodiments of the invention, the system also includes a mechanism for identifying whether the heating element and/or other parts of the system is connected to an electrical grounding. The mechanism allows disconnecting power supply to the heating element(s) once no grounding is identified and notifies the user regarding the detected “no grounding” situation, by presenting an alert through the controller and/or through the remote DCU display options (e.g. by presenting an “error” text message through a screen thereof or through switching on a designated indication LED indicator).

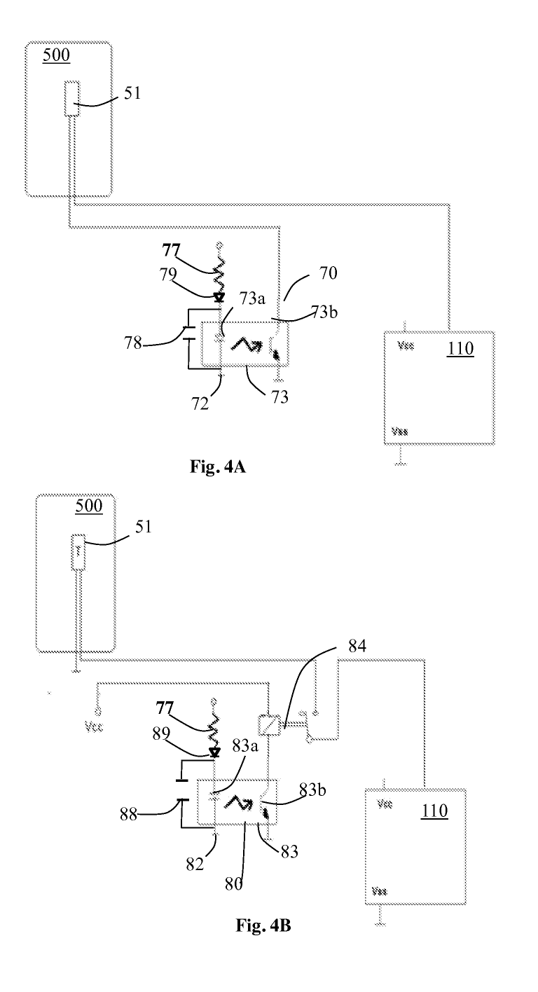

FIG. 4A schematically illustrates a circuit 70, which is a mechanism for detecting connection and disconnection of the heating system to an electric grounding, according to one embodiment of the invention. The circuit 70 may include a sensor such as an optical coupler 73 (also known in the art as an optocoupler, photocoupler or an optical isolator) for sensing disconnection of one or more electric components of the heating system 500 such as the heating element or the thermistor 51 to the electric grounding, where the optocoupler 73 is optionally serially connected to a capacitor 78. The optocoupler 73 connects directly to the thermistor 51 of the container 500 and includes a light emitting diode (LED) light source 73a and an optical sensor switch 73b (such as an optoresistor), where the optocoupler 73 connects between the thermistor 51 and the grounding 72 thereof and serially connects to the controller 110. In this configuration, if no current is applied between the grounding 72 and the thermistor 51, no optical signal is produced by the light source 73a causing the switch of the sensor 73b to open/disconnect causing a short circuit therein. Since the controller 110 is serially connected to the optocoupler 73, the short circuit in the optocoupler 73 will allow electric flow therein. Once there is no grounding 72, the sensor switch 73b closes allowing electric current to flow therethrough, which will damage current supply to the controller 110. A rectifier (e.g. diode) 79 connects to a resistor 77 for rectifying and reducing the AC current before entering the optocoupler 73.

FIG. 4B schematically illustrates a circuit 80 for detecting connection of the heating system to an electric grounding 82, according to another embodiment of the invention. In this case an optocoupler 83 sensor (including similar configuration of a light source 83a and a sensor switch 83b, which serially connects to a capacitor 88) connects to the controller 110 and the thermistor 51 via a relay switch 84. Similarly to the circuit 70 illustrated in FIG. 4A, a rectifier (e.g. diode) 89 connects to a resistor 87 for rectifying and reducing the AC current before entering the optocoupler 83.

Other mechanisms may be used for identifying grounding of the same and/or other electric components of the system such as of the heating element(s) and the like, based on the same or other sensors.

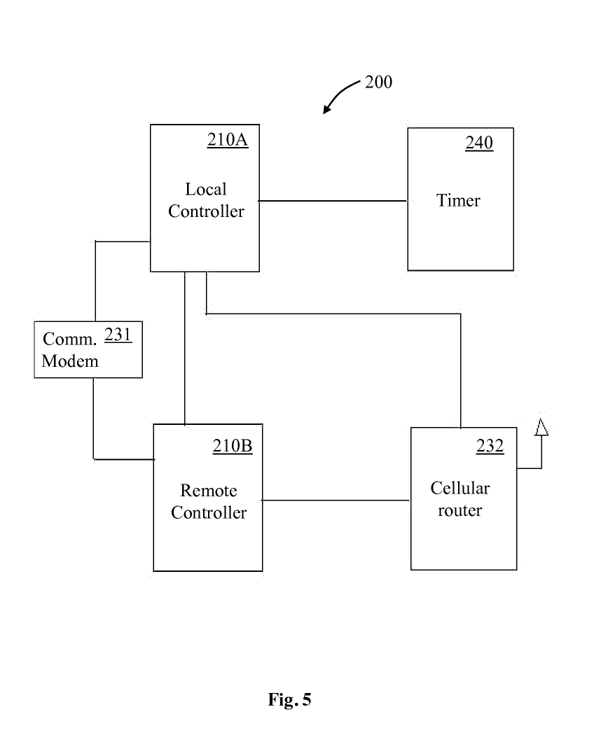

FIG. 5 schematically illustrates a monitoring and control system 200 for a water boiler having a remote controller 210B wirelessly communicative with a local controller 210A through a cellular communication modem 231, according to some embodiments of the invention. According to some embodiments, each controller 210A/210B includes a display and control panel for controlling features of the system (such as controlling various temperature parameters such as Tₘₐₓ, Tₘₕ and the like) and for displaying these input parameters, measured parameters (such as the measured temperature in the container) and other alert messages and the like. The remote controller 210B communicates with the local controller 210A through the communication modem 231 and optionally also through a wireless (cellular) router 232. The system 200 may also include a timer 240 connected to at least one of the controllers 210A/210B through wired or wireless connection, for allowing the user to set the time duration and optionally exact hour for operating the heating element of the boiler, for instance, for turning the boiler on for a set duration of time and optionally for setting the exact hour in which the turning on of the boiler should start.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the invention, will be evident to those skilled in the art. Such changes and modifications are deemed to come within the purview of the invention and the appended claims.

What is claimed is:

1. A monitoring and control system for monitoring and controlling at least one thermal regulation system or TRS, said monitoring and control system comprising:
at least one thermal sensor configured to sense temperature in said TRS;
a controller, operatively associated with said TRS and said thermal sensor, said controller configured to receive data from said thermal sensor including temperature measurements thereof and analyze said data to allow disconnect of said TRS from a power supply once the temperature in said TRS, sensed by said sensor, reaches at least one predefined threshold; and
a breaking mechanism, operatively associated with said controller, comprising at least one circuit breaker configured to disconnect said TRS from said power supply when an electrical overload is identified or once disconnected by said controller operatively associated therewith.

2. The monitoring and control system according to claim 1, wherein said TRS is a heating system comprising at least one container configured to contain a substance therein and at least one heating element inserted in a first inlet therein for heating said substance, wherein said sensor is inserted in a second inlet of said container and said controller enables a disconnect of said power supply from said heating system once temperature in said container reaches a predefined threshold temperature Tₘₐₓ.

3. The monitoring and control system according to claim 2, wherein said heating system is a water boiler comprising a water container and at least one heating element configured to heat the water therein.

4. The monitoring and control system according to claim 2 further comprising at least one display and control unit, which receives data from said controller including currently sensed temperature of said TRS and enables a display thereof using at least one display unit associated therewith.

5. The monitoring and control system according to claim 4, wherein said controller connects to at least one relay connected to said heating element configured to allow a disconnect and a reconnect of said heating element, said display and control unit further configured to enable a user to control settings of said heating system by allowing the user to set at least one of:
a maximal heating temperature Tₘₕ, wherein said controller is configured to enable a disconnect of said heating element once the temperature reaches said Tₘₕ;
a reheating temperature difference ΔTᵣₕ, wherein said controller is configured to allow a reconnect of said heating element once the difference between said Tₘₕ and a currently sensed temperature Tᵢ of the substance in said heating system reaches ΔTᵣₕ;
a timing setup, which is configured to allow an automatic switch of said heating element on by said controller according to said timing setup.

6. The monitoring and control system according to claim 5, wherein said controller is further configured to enable an assessment of a relative heating parameter RHP, indicative of a portion of the substance in said container that has reached the maximal heating temperature Tₘₕ, wherein said display unit enables indication thereof.

7. The monitoring and control system according to claim 4, wherein display unit comprises at least one of: an electronic screen, indicator light sources, electromechanical indicator.

8. The monitoring and control system according to claim 4, wherein said controller is further configured to enable a monitor of temperature changes in said heating system over time and a disconnect of said power supply from said heating system, using said breaking mechanism, once an abnormal temperature is identified and changes, wherein said controller checks whether the temperature in said heating system has not changed over a predefined time period t₀ more than a predefined threshold temperature change ΔTₘᵢₙ and disconnects said heating system once each of the changes within t₀ is lower than ΔTₘᵢₙ.

9. The monitoring and control system according to claim 8, wherein said minimum temperature threshold ΔTₘᵢₙ and said time period t₀ are predefined and are set according to predefined safety standards.

10. The monitoring and control system according to claim 4, wherein said at least one display and control unit comprises at least one proximal display and control unit located in a vicinity to said heating system and controller and at least one remote display and control unit for allowing users to view data relating to said heating system and setting functionality thereof from remote locations, each said remote display and control unit communicates with said controller via at least one communication link.

11. The monitoring and control system according to claim 10, wherein said communication link is one of: a wireless communication link; a wired communication link.

12. The monitoring and control system according to claim 2, further comprising at least one relay connected to said controller configured to allow a disconnect and a reconnect of said heating element thereto to couple said power supply to said heating element.

13. The monitoring and control system according to claim 1, wherein said sensor comprises at least one of: at least one thermistor, a thermocoupler, a resistance thermometer.

14. The monitoring and control system according to claim 2 further comprising a mechanism configured to detect a connection of said TRS to an electric grounding, wherein said controller, connected to said mechanism, disconnects said power supply to the TRS or components thereof, upon identification of no grounding and indication of said identification, said mechanism comprising a sensor for said detection.

15. The monitoring and control system according to claim 1 further comprising an additional at least one remote controller wirelessly communicative with said controller to allow remote display and setting of said controller.

16. A method of monitoring and controlling at least one thermal regulation system or TRS, using a monitoring and control system for monitoring and controlling said TRS, said method comprising:
monitoring temperature of at least part of said TRS, using at least one sensor of said monitoring and control system;
disconnecting a power supply from said TRS when the sensed temperature exceeds a predefined threshold, using a controller of said monitoring and control system, carrying out said monitoring and at least one circuit breaker, of said monitoring and control system, disconnecting and reconnecting of said TRS from said power supply, said controller receiving data from said sensor and controlling said circuit breaker.

17. The method of claim 16, further comprising receiving input data from a user, said data allows setting controlling and monitoring parameters of said monitoring and control system using at least one control and settings unit thereof operatively associated with said controller, wherein said data includes at least one of:
a maximal heating temperature Tₘₕ, wherein said controller enables disconnecting said heating element once the temperature reaches said Tₘₕ;
a reheating temperature difference ΔTᵣₕ, wherein said controller allows reconnecting said heating element for allowing it to reheat said substance once the difference between said Tₘₕ and said a currently sensed temperature of the substance in said heating system reaches ΔTᵣₕ;
a timing setup, which allows automatic switching on said heating element by said controller according to said setup.

18. The method according to claim 16 further comprising monitoring temperature changes in said TRS over time and disconnecting power supply thereto, using said breaking mechanism, once identifying abnormal temperature changes.

19. The method according to claim 18, wherein said controller performs checking whether the temperature in said heating system has not changed over a predefined time period t₀ more than a predefined threshold temperature change ΔTₘᵢₙ and disconnects said TRS once each of the changes within t₀ is lower than ΔTₘᵢₙ.

20. The method according to claim 19, wherein said monitoring and control system further comprising enabling users to set at least one of: said minimum temperature threshold ΔTₘᵢₙ, said time period t₀.

21. The method according to claim 19, wherein said minimum temperature threshold ΔTₘᵢₙ and said time period t₀ are predefined and are set according to predefined safety standards.
